(19) United States
(12) Patent Application Publication
(10) Pub. No.: US 2018/0060834 A1
(43) Pub. Date: Mar. 1, 2018

(54) FINANCIAL TRANSACTION ROUTING

(71) Applicant: First Data Corporation, Greenwood Village, CO (US)

(72) Inventor: Steve Mathison, Omaha, NE (US)

(73) Assignee: First Data Corporation, Greenwood Village, CO (US)

(21) Appl. No.: 15/690,970

(22) Filed: Aug. 30, 2017

Related U.S. Application Data
(63) Continuation of application No. 13/669,224, filed on Nov. 5, 2012, now abandoned.

(51) Int. Cl. G06Q 20/02; G07F 7/08; G06Q 20/20; G06Q 20/34

(52) U.S. Cl. CPC G06Q 20/027; G07F 7/0866; G06Q 20/352; G06Q 20/204; G06Q 20/202

(57) ABSTRACT

Embodiments of the invention are directed toward selecting a preferred transaction application and/or routing options that are provided by a transaction card. The preference can be determined, for example, based on the lowest interchange fee, a bulk rate, and/or an incentive. In some embodiments a transaction card provides a plurality of transaction applications and/or routing options to a POS device and the POS device can communicate these options to a host processor along with transaction data. The host processor can then determine a preference associated with each of the routing options and/or transaction applications, and provide a recommendation to the POS as to which transaction application and/or routing option have preference.

### CROSS REFERENCE TO RELATED APPLICATION

This application is a continuation of U.S. patent application Ser. No. 13/669,224, filed Nov. 5, 2012, entitled “Financial Transaction Routing,” the entire disclosure of which is incorporated herein by reference for all purposes.

### BACKGROUND

Merchants pay an interchange fee for processing debit, credit, and prepaid cards. The interchange fee varies depending on the transaction amount, the bank identifier of the card, the standard industry classification (SIC) code associated with the merchant, and transaction application. The interchange fee structure for various transaction applications varies over time. Some merchants have contracted with specific transaction applications to provide a low cost transaction application. Recent legislation, however, may require that merchants provide consumers with options for different transaction applications. Indeed, some transaction card providers, in particular with their near field contactless (NFC) cards, provide a listing of transaction applications that can be used to process a transaction.

### BRIEF SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Embodiments of the invention are directed toward selecting transaction application and/or routing options that are provided by a transaction card based on transaction application preference. In some embodiments a transaction card provides a plurality of transaction applications and/or routing options to a POS device and the POS device can communicate these options to a host processor along with transaction data. The host processor can then determine the preferred transaction application associated with each of the routing options and/or transaction applications and provide a recommendation to the POS as to which transaction application and/or routing option is preferred.

U.S. patent application Ser. No. 11/682,856, entitled “Least Cost Network Routing for Electronic Transactions,” filed Mar. 6, 2007, is incorporated herein in its entirety for all purposes. U.S. patent application Ser. No. 11/849,670, entitled “Data Element Specific Transaction Routing,” filed Sep. 4, 2007, is incorporated herein in its entirety for all purposes. U.S. patent application Ser. No. 11/852,408, entitled “Electronic Financial Transaction Routing,” filed Sep. 10, 2007, is incorporated herein in its entirety for all purposes. U.S. Pat. No. 6,581,043, entitled “Routing number variable and indexes,” is incorporated herein in its entirety for all purposes.

Some embodiments of the invention are directed toward a method of determining the most beneficial interchange fee transaction application possible. In some embodiments this most beneficial interchange fee transaction application can include the transaction application with the lowest fee. In some embodiments, the most beneficial interchange fee transaction application can include a transaction application that is associated bulk rates or part of an incentive. The method includes receiving transaction data at a point of sale device and receiving a listing of a plurality of transaction applications at the point of sale device a from a transaction card. The plurality of transaction applications and at least a subset of the transaction data from the point of sale device to a host processor are sent to a host processor. Afterwards, an indication of one or more recommended transaction application from the host processor is received. The recommended transaction applications can be, for example, one of the transaction applications from the plurality of transaction applications with the lowest interchange fee, associated with a bulk rate, or part of an incentive. The transaction can then be processed using one of recommended transaction application.

Some embodiments of the invention are directed toward a method of determining the lowest cost transaction application. The method includes at a host processor a listing of a plurality of transaction applications from a point of sale device, and receiving transaction data for a specific transaction from the point of sale device. The interchange fee associated with each transaction application is determined from the plurality of transaction applications based on the transaction data. A recommendation identifying one of the transaction applications from the listing of transaction applications is sent to the point of sale device. In some embodiments, the recommendation is associated with the lowest interchange fee, associated with a bulk rate, or part of an incentive. In some embodiments, the recommendation can be a prioritized list stack rank of transaction applications.

Some embodiments of the invention are directed toward a point of sale device comprising a contactless card reader, a merchant interface, a network interface, and a processor. The processor is configured to receive transaction information from a merchant transaction system though the merchant interface; receive a plurality of transaction applications from a transaction card through the contactless card reader; send the plurality of transaction applications and at least a subset of the transaction information to a host processor through the network interface; and receive a recommendation from the host processor through the network interface indicating a transaction application from the plurality of transaction applications that has the lowest interchange fee.

Some embodiments of the invention are directed toward a host processor that includes a network interface, a database comprising a lookup table that provides interchange fee data for a plurality of transaction applications; and a processor communicatively coupled with the network interface and the database. The processor is configured to receive transaction data from a point of sale device through the network interface, wherein the transaction data comprises a transaction amount and a plurality of transaction applications; determining an interchange fee for each of the plurality of transaction applications; determining the lowest cost interchange fee; and communicate the lowest cost interchange fee to the point of sale device.

### BRIEF DESCRIPTION OF THE DRAWINGS

Illustrative embodiments of the present invention are described in detail below with reference to the following drawing figures:

FIG. 1 shows a system for determining a least cost transaction application in accordance with embodiments of the invention.

FIG. 2 shows a block diagram of an example of a contactless point of sale device that can be used in conjunction with embodiments of the invention.

FIG. 3 shows a block diagram of an example of a contactless payment card that can be used in conjunction with embodiments of the invention.

FIG. 4 is a flowchart of a method for determining a preferred transaction application from a listing of transaction applications found on a transaction card according to some embodiments of the invention.

FIG. 5 is a flowchart of a method for determining a preferred transaction application from a listing of transaction applications found on a transaction card according to some embodiments of the invention.

FIG. 6 shows an illustrative computational system for performing functionality to facilitate implementation of embodiments described herein.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Among other things, embodiments described herein utilize a host processor to determine a preferred transaction application (e.g., with the lowest interchange fee, associated with a bulk rate, associated with an incentive, etc.) from a listing of transaction applications provided by a transaction card through a point of sale (POS) device. For instance, a transaction card can provide a listing of more than one transaction applications that can be used to settle a transaction with a merchant through a point of sale device. The POS device can send this listing of transaction applications to a host processor. The host processor can determine the transaction application from the list of transaction applications that is has preference. The host processor may also provide a preference-ranked listing of transaction applications. The host processor can then communicate the preferred transaction application(s) or a ranked listing of transaction applications to the POS device.

As used herein the term “transaction application” includes any known debit or credit processing scheme or transaction network. For example, a transaction application can include STAR, PULSE, INTERLINK, MAESTRO, CU24, AFFN, ACCEL, EXCHANGE, NETS, SHAZAM, ATH, ALASKA OPTION, JEANIE, TEMPO PAYMENTS, CIRRUS, FASTBANK, INSTANT CASH, MINIBANK, MONEY NETWORK, PEAK, PLUS, NYCE, ALERT, VISA, MasterCard, DISCOVER, PayPal, Google Checkout, American Express, etc. The invention is not so limited, and any debit and/or credit network available in the geographic location of interest may be used in the context of the present invention. Moreover, a transaction application can include one or more routing options.

As used herein the term “Near Field Communication” (NFC) refers to short range wireless technology used to facilitate communication between electronic devices in close proximity. For example, embodiments of the present invention provide for the use of NFC and/or other relatively short range communications between a mobile device and a POS device such as when a user of the mobile device scans or waves the mobile device in front of or near the POS device when paying for goods or services.

A “POS device” refers herein to any physical device situated at a location where a consumer may provide payment in support of a transaction. Such physical locations are typically merchant locations, such as where the POS device is operated by a clerk or is available for self-operation by the consumers (such as a vending machine), but may also be in other locations. For instance, certain automatic teller machines “ATMs” may be equipped to support transactions for the sale of movie or sporting-event tickets even remote from the merchant location; other similar types of transactions that may be performed with a POS device at a location remote from the merchant. In some cases, a personal computer equipped with the appropriate structure may be used as a POS device even when located on the consumer premises. Examples of POS devices thus include, without limitation, personal computers, cash registers, and any devices capable of reading a magnetic stripe, an RFID chip, NFC communications, or other information from a mobile device, contactless device, card, etc.

Exemplary devices that may be adapted for use in various embodiments of the present invention are described in the following commonly assigned applications, the entire disclosures of which are incorporated herein by reference for all purposes: U.S. Provisional Patent Application No. 60/147,889, entitled “Integrated Point of Sale Device,” filed Aug. 9, 1999 by Randy J. Templeton et al.; U.S. patent application Ser. No. 09/634,901, entitled “Point of Sale Payment System,” filed Aug. 9, 2000 by Randy J. Templeton et al.; U.S. patent application Ser. No. 10/116,689, entitled “Systems and Methods for Performing Transactions at a Point-of-Sale,” filed Apr. 3, 2002 by Earney Stoutenburg et al.; U.S. patent application Ser. No. 10/116,733, entitled “Systems and Methods for Deploying a Point-of-Sale System,” filed Apr. 3, 2002 by Earney Stoutenburg et al.; U.S. patent application Ser. No. 10/116,686, entitled “Systems and Methods for Utilizing A Point-of-Sale System,” filed Apr. 3, 2002 by Earney Stoutenburg et al.; and U.S. patent application Ser. No. 10/116,735, entitled “Systems and Methods for Configuring a Point-of-Sale System,” filed Apr. 3, 2002 by Earney Stoutenburg. It should be understood that “POS device” is a term of convenience and can also refer to any terminal/reader that interacts with any presentation instrument, such as a presentation instrument used as a device to gain access to a premises, such as a secure facility.

A “merchant transaction system” refers to a computational system used by merchants to control communications between POS devices and payment networks. Such systems may be run internally by merchants, may be run by merchant consortia, or may be outsourced to service providers in different embodiments. Some exemplary POS processing systems which may be adapted to operate with embodiments of the present invention are described in commonly assigned U.S. Pat. Nos. 6,886,742, 6,827,260 and 7,086,584, the complete disclosures of which are herein incorporated by reference.

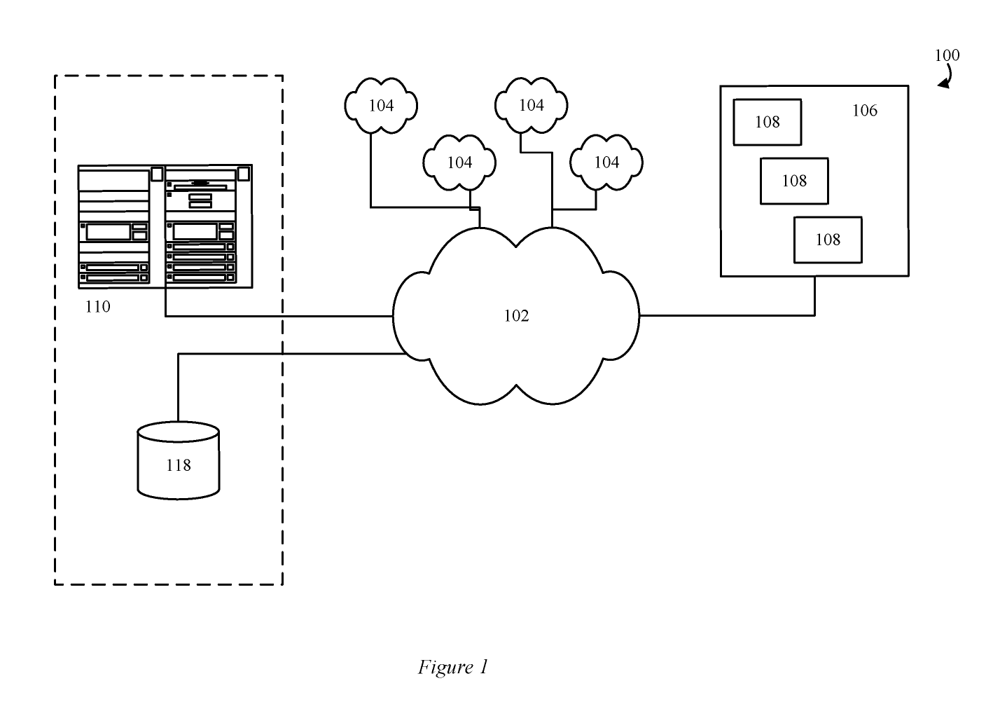

Turning now to FIG. 1, a system 100 is illustrated for determining the least cost transaction application in accordance with embodiments of the invention. System 100 can be implemented in communications network environment (generally indicated by reference number 102). Communications network 102 can be any network capable of supporting electronic transactions, for example, debit and/or credit card transactions. System 100 comprises POS devices 108 located at a merchant location 106 in communication with host processor 110. In some embodiments, a POS device or a group of POS devices can be coupled with the network and/or with host processor 110 through a merchant transaction system. The host processor 110 may include a host computer system at a financial institution or a processing computer system at a financial institution. Host processor 110 is in turn in communication with one or more Database 118 and one or more transaction applications 104. POS device 108, host processor 110, Database 118 and transaction application 104, for example, may be in communication via any suitable communications network 102, such as a local area network, wide area network, the internet and/or any other telecommunications network, a wireless network and the like. Host processor 110 may be located at the merchant location, or alternatively may be located at a service provider location. Likewise, as discussed in more detail herein, Database 118 may be located at the merchant location, or may alternatively be located at a service provider location.

POS device 108 may be an automated teller machine terminal, a cash register terminal, an electronic check verification terminal, part of an Internet based payment server, etc. However, the invention is not so limited, and any device known in the art to collect transaction payment information may be used in connection with the present invention. POS device 108 may include a contactless chip reader and/or a magnetic stripe reader.

In accordance with various embodiments of the invention, system 100 can include a database 118 (or a plurality of databases), which can be used to store a variety of information related to the inventive methods discussed herein such as the transaction table array described above, a SIC table, a BIN table and/or a transaction amount table. Further, although illustrated as separate physical elements in FIG. 1, database 118 may be housed within host processor 110 (as indicated by the dashed line in FIG. 1). When reference is made to host processor 110 including or comprising a database, it is understood that the database may be within the computer housing itself, or may be a separate structure in communication with host processor 110.

In embodiments utilizing the information bus model discussed herein, the information discussed with respect to database 118 may be pushed and/or pulled from a bus, allowing for data acquisition from a wide variety of sources. The term “database”, therefore, should be interpreted to mean a collection of information rather than read as a limitation to a particular physical or logical structure or organization. Database 118 can be in communication with host processor 110 either through transaction application 104 (as illustrated on FIG. 1), through direct communication (e.g., SCSI connection, etc.) and/or through any other method known in the art, so long as host processor 110 can access the information stored within database 118.

Database 118 may comprise various combinations of transaction tables for use to determine the least cost transaction application in accordance with the methods of the invention. For example, database 118 may comprise transaction tables listing transaction applications sorted by interchange fees charged by the transaction application for the particular transaction for which the table has been generated. The tables may provide interchange fees that vary based on the SIC code of the merchant, the BINS of various transaction applications, the transaction amount, among other criteria. Some criteria may be negotiated between the merchant and the host processor.

There are a variety of ways of storing composite information in a database, any of which can be implemented in accordance with various embodiments of the invention. Further, there are a variety of ways in which host processor 110 might interface with database 118. Host processor 110, for example, can access information in database 118 on a periodic basis or on demand. Various standardized (e.g., OOBC, SQL, XML, etc.) and/or proprietary data access methodologies known in the art may be used to access database 118. Further, data may either be pushed from a database or “pulled” by host processor 110.

Alternatively, database 118 and/or host processor 110 can engage in a practice known in the art as “push-pull” data warehousing, whereby information can be shared with and/or pulled from another source, for example, using a relational database. Such data warehousing can be done within an enterprise or between multiple enterprises and can be performed using any of a variety of methods known in the art including, for example, XML data transfers. In these and other ways, embodiments of the present invention, as discussed above, can interface with an information bus operation on an intra-company or inter-company basis, and can both pull information from that bus and push information to the information bus. Thus, systems in accordance with embodiments of the invention can easily integrate with other data management systems in the provider's network, for example, by utilizing the information bus methodology described briefly herein and known in the art.

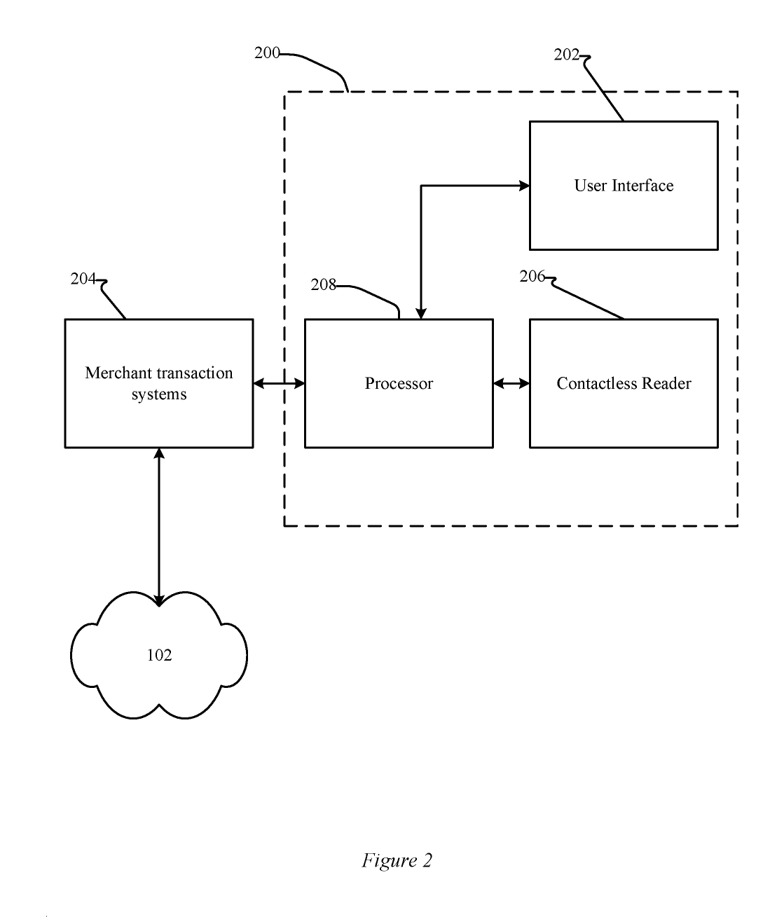

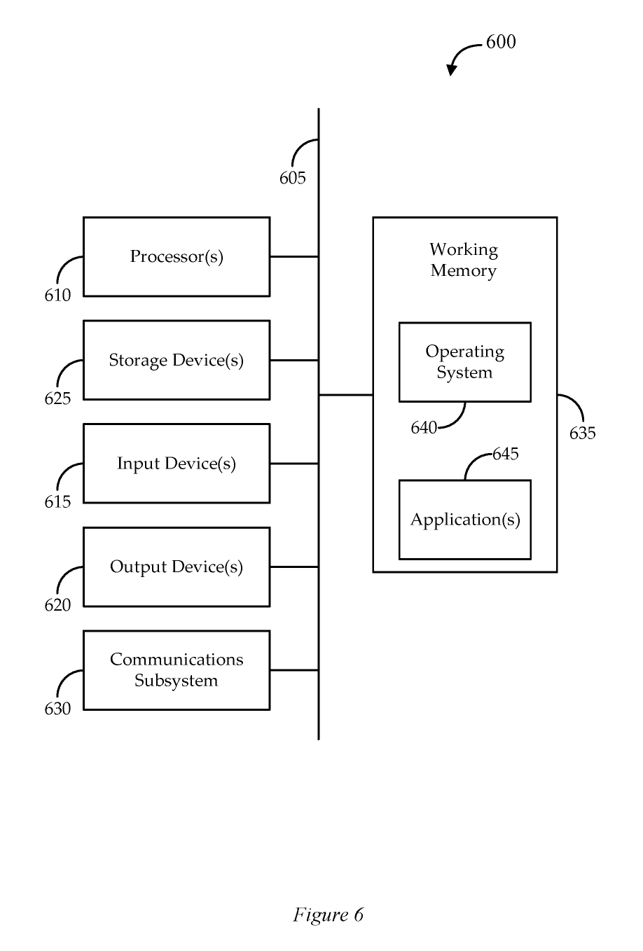

FIG. 2 shows a block diagram of an example of a contactless POS device 200 that can be used in conjunction with embodiments of the invention. POS device 200 includes user interface 202, contactless reader 206, and processor 208. User interface 202 and/or contactless reader 206 can be communicatively coupled with processor 208. Processor 208 can be coupled with merchant transaction system 204 (e.g., a cash register system, or any device that calculates and records a sales transaction). Merchant transaction system 204 can be communicatively coupled with network 102. In some embodiments, POS device 200 can be directly coupled with network 102. In addition, POS device 200 can include various other components such as a processors, circuitry, interfaces, and/or memory (e.g., as described in FIG. 6). In some cases, a personal computer equipped with the appropriate structure may be used as a POS device even when located on the consumer premises.

User interface 202 can include a screen, touch screen, a keypad, and/or buttons that can be used to communicate information to a consumer and/or receive information from the consumer. Contactless reader 206 can include one or more antennas that use radio waves to communicate with, read data on and/or write data on a contactless smart card. Contactless reader 206, for example, can communicate using the ISO/IEC 14443 protocol. Contactless reader 206 can allow for contactless payment of goods or services when it interacts with a contactless payment card. Any type of contactless reader, contactless card, communication protocol, etc. can be used.

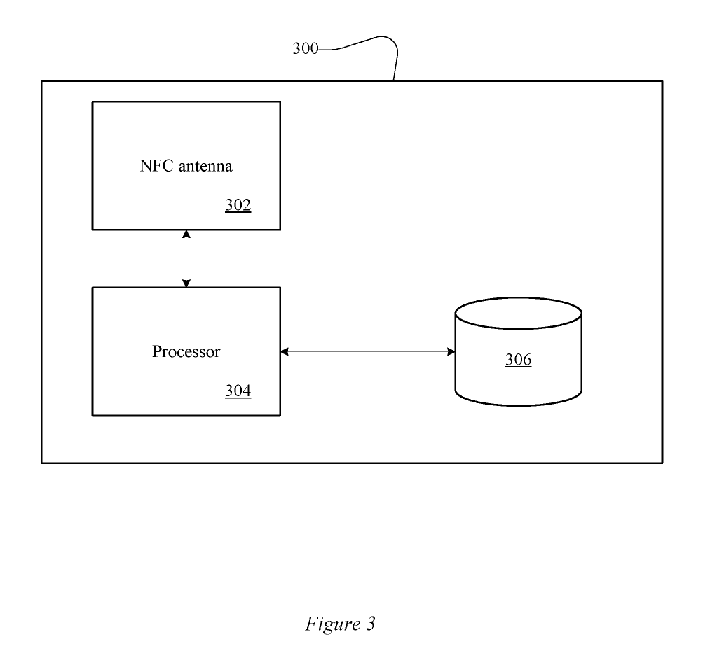

FIG. 3 shows a block diagram of an example of a contactless payment card that can be used in conjunction with embodiments of the invention. Contactless payment card 300 is a device that allows for contactless payment for a retail services or goods. In some embodiments, contactless payment card 300 allows a consumer to conduct an electronic transaction (for example, a credit transaction or a debit transaction) without the need to swipe a credit card or a debit card. For example, contactless payment card 300 may be VISA's payWave contactless application.

In some embodiments, contactless payment card 300 can include a near field communication (NFC) antenna 302 for communicating with NFC payment sensors, processor 304, database 306, and database 306. The NFC antenna 302 may be a radio frequency identification device (RFID) or other type device that can send and receive information associated with a transaction. For example, NFC antenna 302 can be the PN531 transmission module offered by NXP Semiconductors, Eindhoven, Netherlands.

Processor 304 can provide logic that can perform specific tasks, for example, in response to input from NFC antenna 302. For example, processor 304 can receive requests for specific data from a POS device through NFC antenna 302. In response, processor 304 can retrieve data from database 306 and communicated the data to the POS device through NFC antenna 302. Database 306 can include, for example, account numbers (e.g., credit card numbers, bank identification numbers (BIN), debit card numbers, check card numbers, etc.), user information (e.g., name, address, etc.), a listing of transaction applications, etc.

While FIGS. 2 and 3 show block diagrams of contactless transaction card systems, embodiments of the invention are not limited to such devices. Indeed, embodiments of the invention can be implemented using any type of system where a transaction card communicates transaction data to a POS device. For example, transaction cards with magnetic stripes can be used.

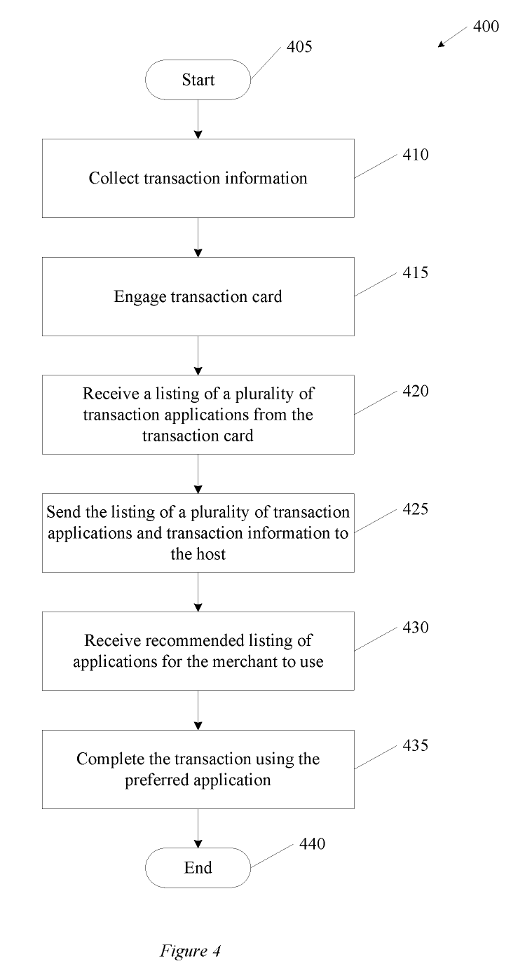

FIG. 4 is a flowchart of method 400 for determining one or more preferred transaction application(s) from a listing of transaction applications found on a transaction card according to some embodiments of the invention. These preferred transaction applications can be preferred for being associated with the lowest interchange fee, associated with a bulk rate, or part of an incentive. Method 400 can occur at a POS device and/or may be executed by processor 208. Method 400 starts at block 405. At block 410 transaction information is collected. This transaction information, for example, can be collected by a clerk or teller at a merchant location through a cash register system. Transaction information may also be collected, for example, through a POS device or a mobile POS device. Transaction information can include the transaction amount and or the SIC code associated with the transaction. Various other transaction data may be collected.

At block 415 the transaction card is engaged. This can occur, for example, between contactless payment card 300 and POS device 200. In particular, this engagement can occur using any near field communication technology and/or protocols and or RFID technology and/or protocols. Details about the consumer and/or payment can be communicated from the transaction card to the POS device. At block 420 a listing of a plurality of transaction applications can be received from the transaction card. For example, the contactless payment card may include a listing of a plurality of transaction applications that can be used to process the transaction.

At block 425 the listing of the transaction applications, transaction information, and/or the SIC code associated with the merchant can be sent to the host processor (e.g., host processor 110). In some embodiments the SIC code may be known by the host processor. In some embodiments the listing of transaction applications can include the name of the transaction application or a listing of codes corresponding to the transaction applications.

In some embodiments, a recommendation can be received from the host processor indicating the preferred transaction application for the given transaction at block 430. In some embodiments, the recommendation can include a prioritized listing of the transaction applications in order from the lowest interchange fee to the highest interchange fee (or vice versa) or other criteria.

For example, if at block 425, the following transaction applications are sent to the host processor as transaction applications that can be used by the contactless card:

MAESTRO
Visa
Interlink

Alternatively, the listing of transaction applications can include codes representing each transaction application. For example, the code can correspond with the registered application provider identifier (RID) and/or the proprietary application identifier extension (PIX).

A000000004-3060
A000000003-1010
A000000003-3010

In this example, each transaction application can be associated with a known code. Any type of coding can be used. In response, the host processor can return the name of the transaction application, the listing number associated with the transaction operation, and/or the code associated with the transaction operation that is the most preferred.

Alternatively, an array of values can be returned that includes the ranked order of transaction operation from lowest to highest preference:

Interlink
Visa
MAESTRO

In this way, if the most preferred transaction application is unavailable the next preferred transaction application can be used. This array could include a listing of the codes instead of the names of the transaction applications. Alternatively, an array of numbers can be returned that indicates the order of preference based on the preference of the transaction applications. In this example, the array would be [3, 2, 1]. “Interlink” was the third value in the listing and is now considered the preferred transaction application; therefore, the number three is the first in the array indicating the third listed transaction application has the highest preference.

At block 430 the preferred transaction application can be used to complete the transaction. If the preferred transaction application is unavailable, the next ranked transaction application can be used. Method 400 can end at block 440.

In some embodiments, the transaction card may provide a single application that is associated with a plurality of routing options within the single application. In this scenario, the POS device can send the various routing options to the host processor and receive an indication regarding the preferred transaction application routing option in a similar manner. Alternatively, the POS can provide the one or more applications to the host processor, and the host processor can determine whether there are a plurality of routing options associated with each of the transaction applications and then determine the preferred transaction application.

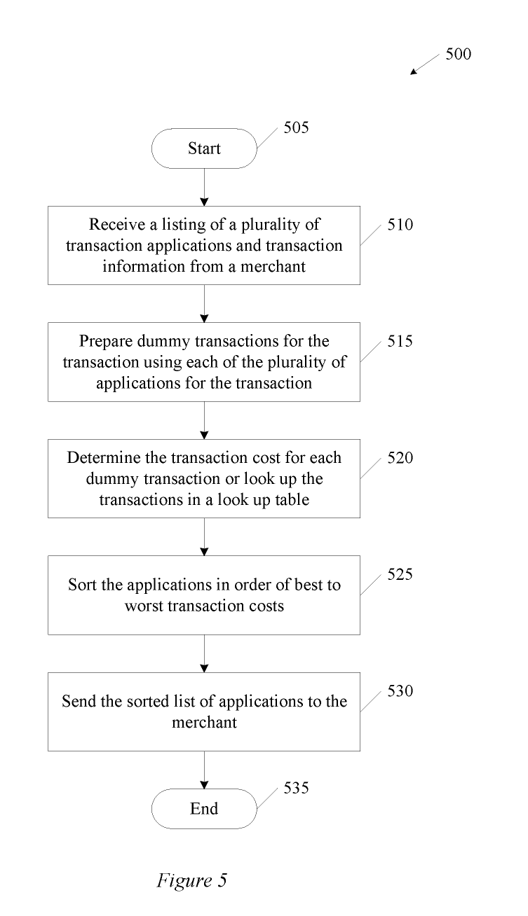

FIG. 5 is a flowchart of method 500 for determining a preferred transaction application from a listing of transaction applications provided by a transaction card according to some embodiments of the invention. Method 500 can be performed by a host processor. Method 500 can start at block 505. At block 510 a listing of a plurality of transaction applications can be received from a POS device at a merchant location. This can correspond, for example, to the data sent in block 425 of FIG. 4. As noted above, this listing can include a list of names and/or codes associated with transaction applications.

At block 515 the host processor can prepare a dummy transaction using the transaction information for each of the transaction applications in the listing of transaction applications. At block 520, the host processor can use current tables stored in a database (e.g., Database 118) to determine the transaction interchange fees associated with each dummy transaction using each transaction application. In some embodiments, dummy transactions may not be required.

Host processor can sort the application in order of lowest to highest preference transaction application at block 525 and send an array of transaction application names, an array of codes representing transaction applications, or an array of numbers associated with the transaction application in the order received at block 530. Method 500 can end at block 535.

For example, suppose that host processor received the following transaction information: transaction amount: $345, SIC code: 441320 (tire dealers), and BIN: 553421 (Bank of Scotland Mastercard). The host processor can also receive the following listing of transaction applications:

Interlink
Visa
MAESTRO

For example, the host processor can use the SIC code to lookup the appropriate table within the database and then identify the interchange fees associated with each of the transaction applications based on the BIN and/or the transaction amount. In response, the estimated interchange fees can be returned for each transaction application. An example is shown below:

| | |
|---|---|
| MAESTRO | $0.16 |
| Visa | $0.09 |
| Interlink | $0.07 |

In this embodiment, the host processor can sort the transaction applications according to lowest to highest interchange fees. Then the host processor can send either an array of transaction application names, an array of codes representing transaction applications, or an array of numbers associated with the transaction application in the order received.

In some embodiments, the POS device may provide a listing of routing options with or instead of the transaction applications. In this scenario, the host processor can determine the preferred transaction application options based on the routing options provided by the POS device. Alternatively, the POS device can provide one or more applications to the host processor, and the host processor can determine each transaction application includes different routing options associated with the single transaction application and then determine the preferred transaction application options from the various routing options.

The computational system 600, shown in FIG. 6, can be used wholly, in part, or in conjunction with other components for the POS device and/or the host processor among other devices described herein. Computational system 600 is shown to include hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments of the invention rely on a host processor to determine a preferred transaction application. This preference can be determined in a number of ways. In some embodiments, the preference can be determined based on the transaction routing cost. For example, dummy transactions can be attempted and actual transaction costs determined. As another example, predetermined tables can be used to look up a preferred transaction application based on the merchant, SIC code and/or transaction amount. Any number of techniques can be used so long as a preference is returned to the POS device. The preference may also be determined based on a bulk rate negotiated between the merchant and/or host with the transaction application (or network). For example, if a merchant is afforded a discount based on a predetermined number of transactions being routed using the transaction application in a given period of time, then that transaction application may receive preference if the predetermined number has not been reached and/or the period of time is nearing an end. Moreover, some transaction application (or networks) may provide incentives based on any number of factors at any given time. These incentives may be used to determine a preferred network.

In one aspect, the invention employs the computational system 600 to perform methods of the invention. According to a set of embodiments, some or all of the procedures of such methods are performed by the computational system 600 in response to processor 610 executing one or more sequences of one or more instructions (which might be incorporated into the operating system 640 and/or other code, such as an application program 645) contained in the working memory 635. Such instructions may be read into the working memory 635 from another machine-readable medium, such as one or more of the storage device(s) 625. For example, execution of the sequences of instructions contained in the working memory 635 might cause the processor(s) 610 to perform one or more procedures of the methods described herein.

The terms “machine-readable medium” and “computer readable medium”, as used herein, refer to any medium that participates in providing data that causes a machine to operate in a specific fashion. In an embodiment implemented using the computational system 600, various machine-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 625. Volatile media includes, without limitation, dynamic memory, such as the working memory 635. Transmission media includes coaxial cables, copper wire and fiber optics, including the wires that comprise the bus 605, as well as the various components of the communication subsystem 630 (and/or the media by which the communications subsystem 630 provides communication with other devices).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 610 for execution. For example, the instructions may initially be carried on a magnetic disk and/or optical disc of a remote computer. A remote computer might load the instructions into its dynamic memory and send the instructions as signals over a transmission medium to be received and/or executed by the computational system 600. The communications subsystem 630 (and/or components thereof) generally will receive the signals, and the bus 605 then might carry the signals (and/or the data, instructions, etc., carried by the signals) to the working memory 635, from which the processor(s) 605 retrieves and executes the instructions. The instructions received by the working memory 635 may optionally be stored on a storage device 625 either before or after execution by the processor(s) 610.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. (canceled)

2. A point of sale device comprising:
a near field communication (NFC) reader;
a merchant interface;
a network interface; and
a processor communicatively coupled with the NFC reader, the merchant interface, and the network interface, wherein the processor is configured to:
receive transaction information from a merchant transaction system through the merchant interface, wherein the transaction information comprises a transaction amount and an industry classification code;
receive a plurality of transaction applications from a transaction card through the NFC reader, wherein each of the plurality of transaction applications comprises a plurality of routing options, and wherein each of the plurality of transaction applications comprises a banking identification number (BIN);
send at least a subset of the transaction information and a plurality of codes that represent each of the plurality of transaction applications to a host processor through the network interface, wherein the subset comprises the industry classification code, and wherein the industry classification code is used by the host processor to retrieve a corresponding transaction application array from at least one database, wherein the database is accessed using one or more data access methodologies selected from the list consisting of OOBC, SQL, and XML;
receive a recommendation from the host processor through the network interface indicating a preferred transaction application and at least one alternative transaction application from the plurality of transaction applications, the recommendation comprising at least a portion of the corresponding transaction application array, wherein the preferred transaction application and the at least one alternative transaction application are selected and ordered based on a preferred one of the plurality of routing options and an incentive received or a transaction cost, and wherein the incentive received or the transaction cost is determined based on the transaction amount and the BIN.

3. The point of sale device of claim 2, wherein:
each of the plurality of codes corresponds with one or both of a registered application provider identifier and a proprietary application identifier extension.

4. The point of sale device of claim 2, wherein:
the corresponding transaction array comprises ranked order of the plurality of transaction applications based on a preference of each of the plurality of transaction applications.

5. The point of sale device of claim 2, wherein:
at least one of the plurality of transaction applications comprises a plurality of routing options; and
the processor is further configured to:
deliver the plurality of routing options to the host processor; and
receive an indication of a preferred one of the plurality of routing options from the host processor.

6. The point of sale device of claim 2, wherein:
the incentive received or the transaction cost is determined by performing a dummy transaction using each of the plurality of transaction applications based on the transaction amount and the BIN.

7. The point of sale device of claim 2, wherein:
the database comprises a relational database that is accessed using XML, data transfers.

8. A point of sale device comprising:
a near field communication (NFC) reader;
a merchant interface;
a network interface; and
a processor communicatively coupled with the NFC reader, the merchant interface, and the network interface, wherein the processor is configured to:
receive transaction information from a merchant transaction system through the merchant interface, wherein the transaction information comprises a transaction amount and an industry classification code;
receive a plurality of transaction applications from a transaction card through the NFC reader, and wherein each of the plurality of transaction applications comprises a banking identification number (BIN);
send the plurality of transaction applications and at least a subset of the transaction information to a host processor through the network interface, wherein the subset comprises the industry classification code, and wherein the industry classification code is used by the host processor to retrieve a corresponding transaction application array from at least one database;
receive a recommendation from the host processor through the network interface indicating a preferred transaction application and at least one alternative transaction application from the plurality of transaction applications, the recommendation comprising at least a portion of the corresponding transaction application array, wherein the preferred transaction application and the at least one alternative transaction application are selected and ordered based on an incentive received or a transaction cost, and wherein the incentive received or the transaction cost is determined based on the transaction amount and the BIN.

9. The point of sale device according to claim 9, wherein the processor is further configured to:
attempt to settle the transaction using one of the plurality of transaction applications recommended by the host processor.

10. The point of sale device according to claim 9, wherein:
the network interface and the merchant interface are a single interface.

11. The point of sale device according to claim 9, wherein:
the corresponding transaction array comprises ranked order of the plurality of transaction applications based on a preference of each of the plurality of transaction applications.

12. The point of sale device according to claim 9, wherein the processor is further configured to:
receive a bank identification number from the applications from a transaction card through the NFC reader; and
send the bank identification number to the host processor through the network interface.

13. The point of sale device according to claim 9, wherein the processor is further configured to:
send an identifier identifying the merchant to the host processor through the network interface.

14. The point of sale device according to claim 9, wherein:
at least one of the plurality of transaction applications comprises a plurality of routing options; and
the processor is further configured to:
deliver the plurality of routing options to the host processor; and
receive an indication of a preferred one of the plurality of routing options from the host processor.

15. The point of sale device according to claim 9, wherein:
the incentive received or the transaction cost is determined by performing a dummy transaction using each of the plurality of transaction applications based on the transaction amount and the BIN.

16. A system for providing a transaction application suggestion, comprising:
a point of sale device comprising:
a near field communication (NFC) reader;
a merchant interface;
a point of sale network interface; and
a first processor communicatively coupled with the NFC reader, the merchant interface, and the point of sale network interface, wherein the first processor is configured to:
receive transaction information from a merchant transaction system through the merchant interface, wherein the transaction information comprises a transaction amount and an industry classification code;
receive a plurality of transaction applications from a transaction card through the NFC reader, and wherein each of the plurality of transaction applications comprises a banking identification number (BIN);
send the plurality of transaction applications and at least a subset of the transaction information to a host processor through the network interface, wherein the subset comprises the industry classification code;
receive a recommendation from the host processor through the point of sale network interface indicating a preferred transaction application and at least one alternative transaction application from the plurality of transaction applications, wherein the preferred transaction application and the at least one alternative transaction application are selected and ordered based on an incentive received or a transaction cost, and wherein the incentive received or the transaction cost is determined based on the transaction amount and the BIN; and
the host processor comprising:
a host processor network interface;
a database; and
a second processor communicatively coupled with the host processor network interface and the database, wherein the second processor is configured to;
receive the subset of the transaction information and the plurality of transaction applications from the point of sale device through the host processor network interface, wherein the subset of the transaction information comprises the industry classification code;
retrieve a corresponding transaction application array from the database based on the industry classification code;
determine the preferred transaction application and at least one alternate transaction application; and
communicate the preferred transaction application and the at least one alternate transaction application to the point of sale device.

17. The system for providing a transaction application suggestion of claim 16, wherein:
the recommendation comprises at least a portion of the corresponding transaction application array.

18. The system for providing a transaction application suggestion of claim 16, wherein:
the corresponding transaction array comprises the plurality of transaction applications sorted by interchange fees.

19. The system for providing a transaction application suggestion of claim 16, wherein:
the host processor accesses the database using one or more data access methodologies selected from the list consisting of OOBC, SQL, and XML.

20. The system for providing a transaction application suggestion of claim 16, wherein:
the database comprises a relational database that is accessed using XML, data transfers.

21. The system for providing a transaction application suggestion of claim 16, wherein:
the second processor is further configured to:
perform a dummy transaction to determine the incentive received or the transaction cost associated with each of the plurality of transaction applications, wherein the dummy transaction is performed based on the transaction amount and the BIN.
